(19) United States
(12) Patent Application Publication
(10) Pub. No.: US 2002/0063715 A1
(43) Pub. Date: May 30, 2002

(54) System, method, and computer program product for capturing a visualization session

(75) Inventor: James L. Foran, San Jose, CA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: Silicon Graphics, Inc.

(21) Appl. No.: 09/995,668

(22) Filed: Nov. 29, 2001

Related U.S. Application Data
(60) Provisional application No. 60/253,947, filed on Nov. 30, 2000.

(51) Int. Cl. G06T 1/00

(52) U.S. Cl. 345/501

(57) ABSTRACT

A system and method are provided for automatically capturing a graphics session so that the session can be subsequently re-created in a precise manner. In some embodiments, the image data produced by the rendering process is recorded and stored in a memory medium. The image data can then be used to re-create the images produced by the original rendering process. The image data can be collected through a connection at the graphics processing host, at the client computer from which the graphics session is controlled, or at an intermediate point. In other embodiments, the initial state of the graphics processing host is captured, where the initial state includes the graphics data to be rendered. In addition, commands sent to the graphics processing host to control the graphics session are also captured. These commands are typically sent by the client computer from which the session is controlled. By capturing both the initial state of the graphics processing host and the commands that manipulate the initial state, the graphics session itself is precisely captured. The session can then be re-created by applying the commands to the initial state of the graphics processing host.

CROSS-REFERENCE TO RELATED APPLICATIONS

This application claims priority to U.S. Provisional Patent Application No. 60/253,947, filed Nov. 30, 2000, and incorporated herein by reference in its entirety.

This invention is also cross-referenced to the following patent applications:

U.S. patent application Ser. No. 09/520,898, “Method for Providing Remote Access to Graphics Processing Resources,” filed on Mar. 7, 2000; and

U.S. patent application Ser. No. 09/629,458, “System, Method, and Computer Program Product for Remote Graphics Processing,” filed on Jul. 31, 2000.

These applications are incorporated herein by reference in their entirety.

### BACKGROUND OF THE INVENTION

1. Field of the Invention

The invention pertains to computer graphics, and more particularly to the processing of image data.

2. Related Art

Currently, the capture of a computer graphics session is video oriented. Capture typically entails recording of the rendered image data in its displayed form onto some analog or digital video medium. The video of the session can, for example, be saved on video tape using a videocassette recorder. Alternatively, conversion can be performed according to the Moving Pictures Expert Group (MPEG) standard and the video stored on a hard disk or other computer-readable medium, for subsequent conversion to a digital video disc (DVD). This process is cumbersome and not well integrated into the process of operating a graphics system.

Hence there is a need for a way to automatically capture an interactive graphics session for later playback and review, where the capture is unobtrusive with respect to system operation.

### SUMMARY OF THE INVENTION

The invention described herein is a system and method for automatically capturing a graphics session so that the session can be subsequently re-created in a precise manner. In some embodiments of the invention, the image data produced by the rendering process is recorded and stored in a memory medium. The image data can then be used to faithfully re-create the images produced by the original rendering process. The image data can be collected through a connection at the graphics processing host, at the client computer from which the graphics session is controlled, or at an intermediate point.

In other embodiments of the invention, the initial state of the graphics processing host is captured, where the initial state includes the graphics data to be rendered. In addition, commands sent to the graphics processing host to control the graphics session are also captured. These commands are typically sent by the client computer from which the session is controlled. By capturing both the initial state of the graphics processing host and the commands that manipulate the initial state, the graphics session itself is precisely captured. The session can then be re-created by applying the commands to the initial state of the graphics processing host.

The invention has the feature of automatically collecting graphics information that allows re-creation of a graphics session.

The invention has the advantage of facilitating the display of rendered images at any time subsequent to the initial rendering and display. The invention has the further advantage of allowing a graphics application to be analyzed and debugged, by allowing a review of a graphics session. The invention has the further advantage of allowing the editing of one or more rendered image sequences.

### BRIEF DESCRIPTION OF THE FIGURES

The foregoing and other features and advantages of the invention will be apparent from the following, more particular description of a preferred embodiment of the invention, as illustrated in the accompanying drawings.

FIG. 1 illustrates a system for conducting a remote graphics session.

FIG. 2 illustrates a system for conducting a remote graphics session, where image data is recorded at a remote client, according to an embodiment of the invention.

FIG. 3A illustrates a system for conducting a remote graphics session, where image data is recorded at a graphics processing host, according to an embodiment of the invention.

FIG. 3B illustrates a system for conducting a remote graphics session, where compressed image data is recorded at a graphics processing host, according to an embodiment of the invention.

FIG. 4 illustrates a system for conducting a remote graphics session, where the initial state of a graphics processing host and the commands of a remote user are recorded, according to an embodiment of the invention.

FIG. 5 is a flowchart illustrating the overall method of an embodiment of the invention, wherein graphics information is recorded.

FIG. 6 is a flowchart illustrating the overall method of an alternative embodiment of the invention, wherein the initial state of a graphics processing host and commands sent to the host are recorded.

### DETAILED DESCRIPTION OF THE PREFERRED EMBODIMENTS

A preferred embodiment of the present invention is now described with reference to the figures where like reference numbers indicate identical or functionally similar elements. Also in the figures, the left most digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other devices and applications.

System

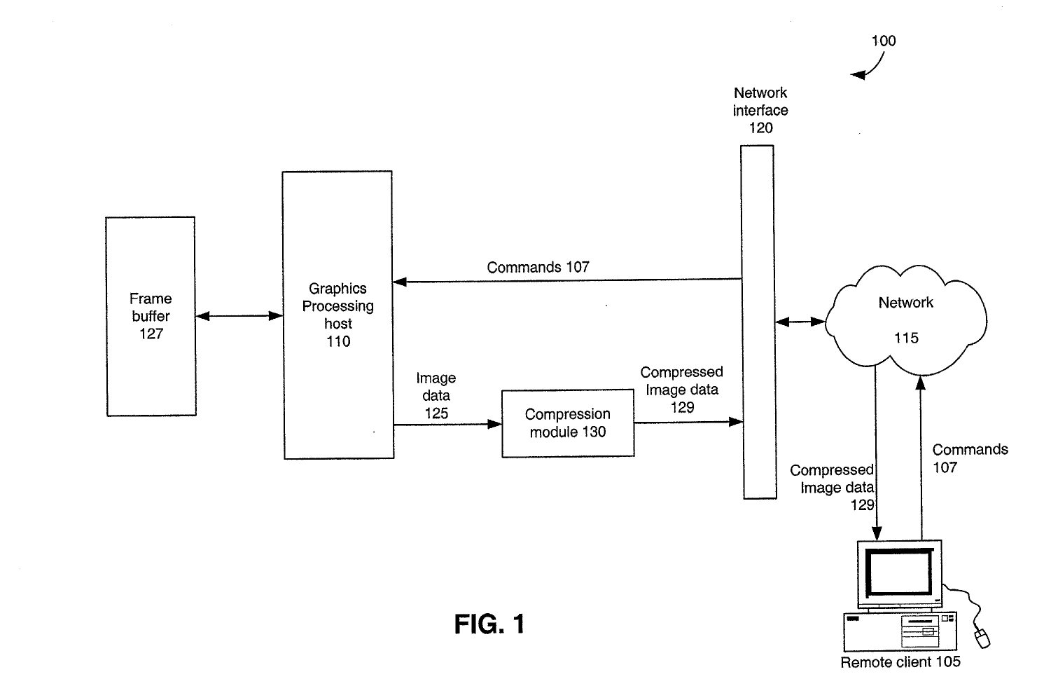

FIG. 1 illustrates an exemplary system 100 in which graphics processing resources can be provided to a user. In this example, the user is situated at a client machine that is remote from a graphics host. A remote client 105 is shown having connectivity to a graphics machine, host 110. The remote client 105 can send commands 107 to host 110 through a computer network 115, such as the Internet, and through a network interface 120. In response to commands 107, host 110 can then render the graphics data to form image data 125, which is initially stored in a frame buffer 127. The image data 125 can then be read back from the frame buffer 127 by host 110 and sent to remote client 105. This process is typically repeated many times each second.

In an embodiment of the invention, the image data may be of such a quantity that compression is required in order to efficiently send the image data to remote client 105 via network 115. Compression is performed by a compression module 130. Compression may be performed by hardware, software, or a combination thereof, forming compressed image data 129. While compression module 130 is shown in FIG. 1 as a module external to host 110, compression module 130 can alternatively be internal to host 110, or embodied as software executing on host 110. Decompression can be performed internally to remote client 105. Moreover, the volume of image data may necessitate a high capacity communications medium, such as OC-48 fiber optic cable.

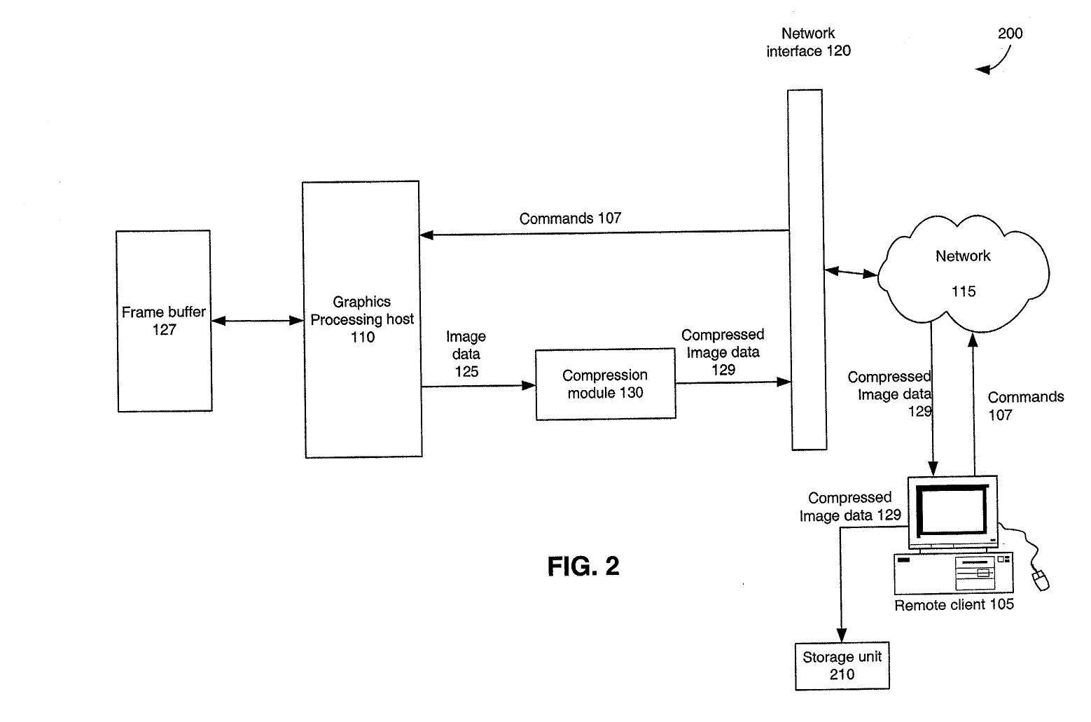

In order to allow subsequent re-creation of a graphics session, graphics information is captured. In an embodiment of the invention, the graphics information captured is the image data itself. One example system for capturing image data is shown in FIG. 2. As in FIG. 1, remote client 105 is shown issuing commands 107 to graphics processing host 110. Image data 125 is written to frame buffer 127, then read back and returned to remote client 105. In the embodiment of FIG. 2, compressed image data 129 is captured at a storage unit 210. Storage unit 210 can utilize a disk drive (e.g., hard disk, floppy disk, or compact disk), a magnetic tape, random access memory (RAM), or some other data storage medium, or some combination thereof. In the illustrated embodiment, storage unit 210 is shown as being external to remote client 105. In an alternative embodiment, storage unit 210 can be internal to remote client 105.

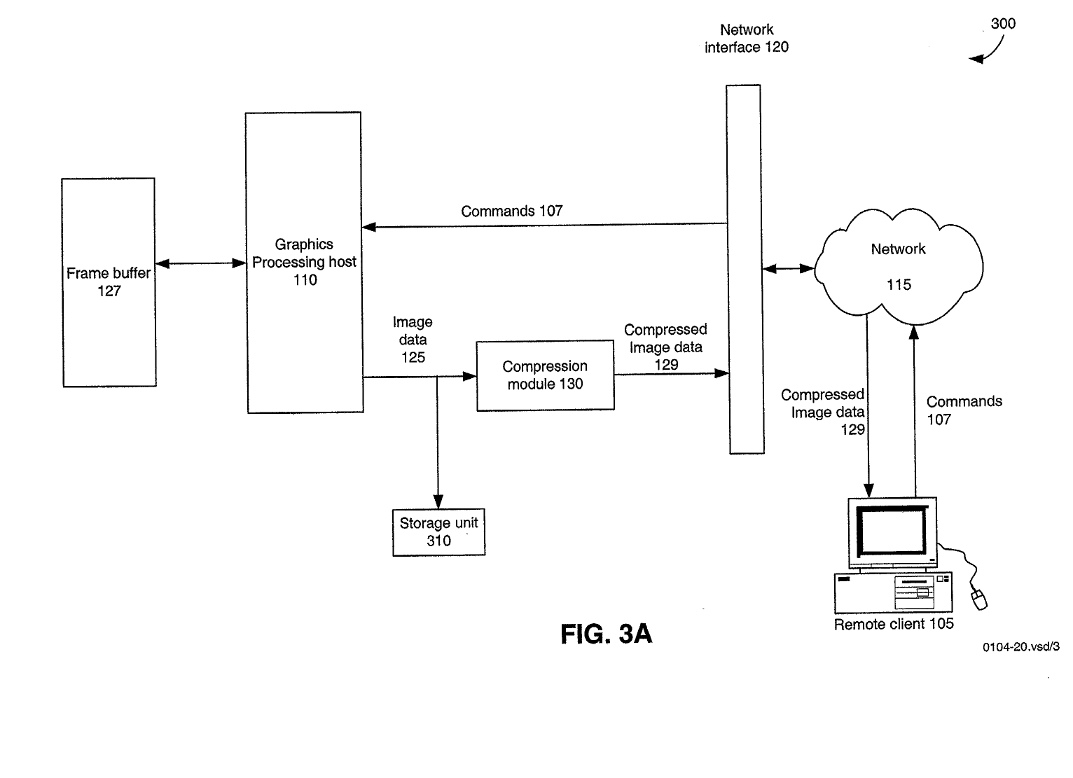

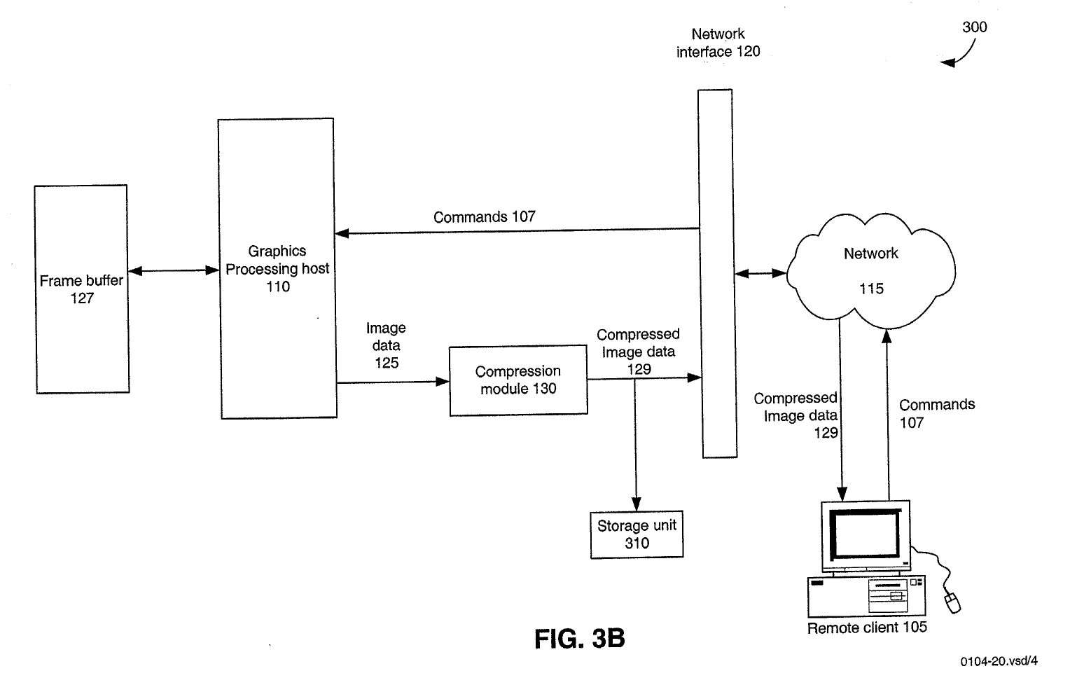

FIG. 3A illustrates another embodiment of the invention. Here, capture of image data 125 is performed locally to graphics processing host 110 at a storage unit 310. As in the embodiment of FIG. 2, storage unit 310 can utilize a disk drive (e.g., hard disk, floppy disk, or compact disk), a magnetic tape, random access memory (RAM), or some other data storage medium, or some combination thereof. In the illustrated embodiment, storage unit 310 is shown as being external to graphics host 110. In an alternative embodiment, storage unit 310 can be internal to graphics host 110.

Another embodiment is shown in FIG. 3B. Here, storage unit 310 collects compressed image data 129, rather than image data 125. As in FIG. 3A, capture of image data in this embodiment is performed locally to graphics processing host 110.

While FIG. 2 shows graphics information (i.e., image data 125) being collected at the remote client 105 and FIG. 3 shows graphics information being collected at the host 110, the graphics information could alternatively be recorded elsewhere. For example, the graphics information could be recorded at an intermediate point between host 110 and client 105.

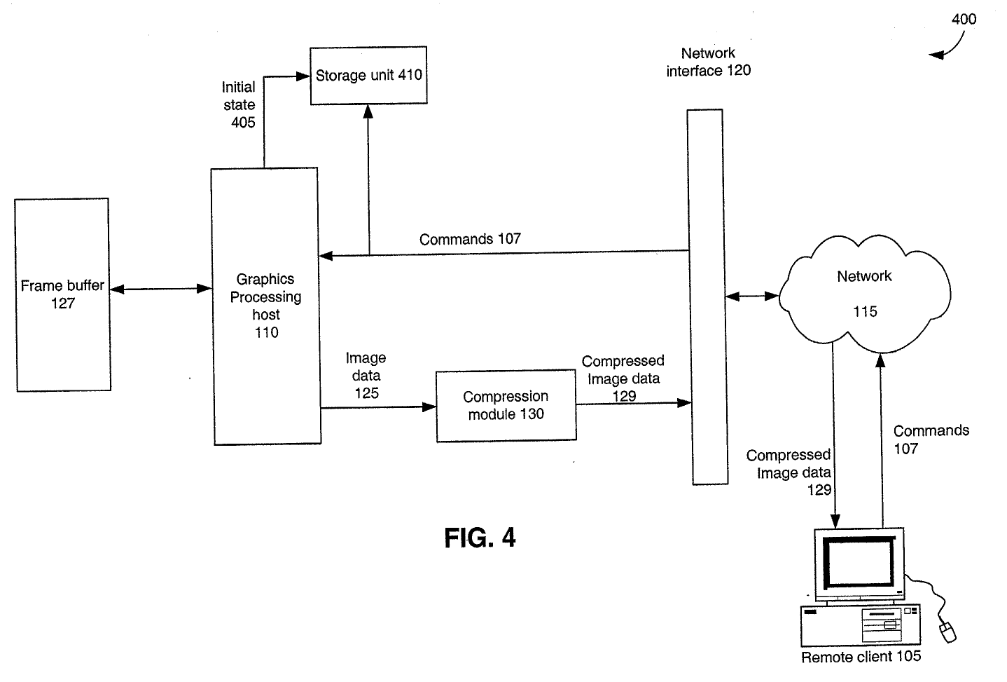

Another way to capture graphics information such that a graphics session can be subsequently re-created is to record the initial state of the host and the commands sent by the user to the graphics host. This is illustrated in FIG. 4. The illustrated system is similar in some respects to that of FIG. 1. Remote client 105 is shown issuing commands 107 to graphics processing host 110. Image data is written to frame buffer 127, then read back and returned to remote client 105. In FIG. 4, however, an initial state 405 of graphics processing host 110 is recorded at a storage unit 410 prior to initiation of the graphics session. The initial state 405 includes the graphics data that will be used in the rendering process. During the graphics session, the commands 107 used to control the session are recorded. By recording both the initial state 405 of graphics host 110 and the commands 107 that alter the state of host 110, the session is effectively captured. The session and the resulting display can be re-created exactly, by executing the recorded commands 107 with respect to the initial state 405.

As in the previous embodiments, storage unit 410 can utilize a disk drive (e.g., hard disk, floppy disk, or compact disk), a magnetic tape, random access memory (RAM), or some other data storage medium, or some combination thereof. In the illustrated embodiment, storage unit 410 is shown as being external to graphics host 110. In an alternative embodiment, storage unit 410 can be internal to graphics host 110.

Method

In the method of the invention, graphics information is recorded so that the results of a graphics session can be precisely re-created at some later time.

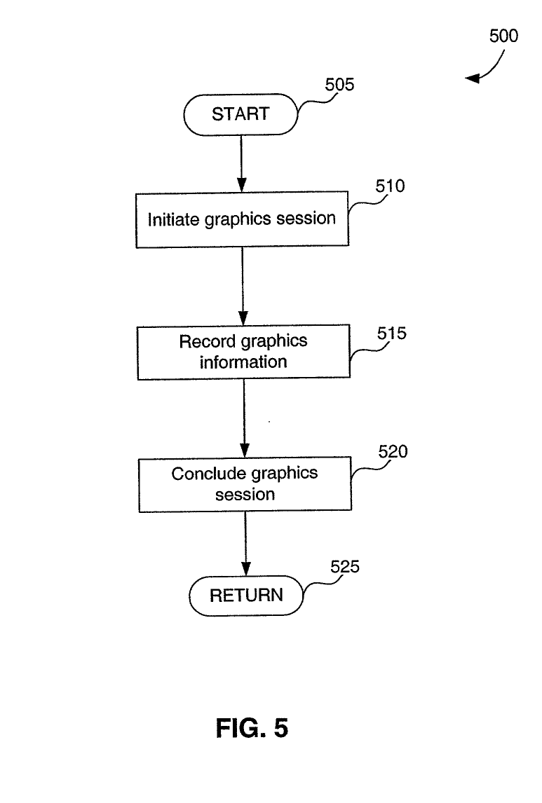

One embodiment of the method of the invention is illustrated in FIG. 5. Method 500 begins at step 505. In step 510, a graphics session is initiated at a graphics host processor. As described above, such a session can be remotely controlled by a user at a client machine. In such an arrangement, the client machine is physically distant from the graphics host at which the rendering takes place. In step 515, graphics information that results from the graphics session is recorded. The graphics information can be rendered image data. In an embodiment of the invention, the image data is compressed before recording. As described above, the graphics information can be recorded at the host, at the client, or at an intermediate point. The graphics information could alternatively be recorded at an intermediate point between the two. In step 520, the graphics session ends. Method 500 concludes at step 525.

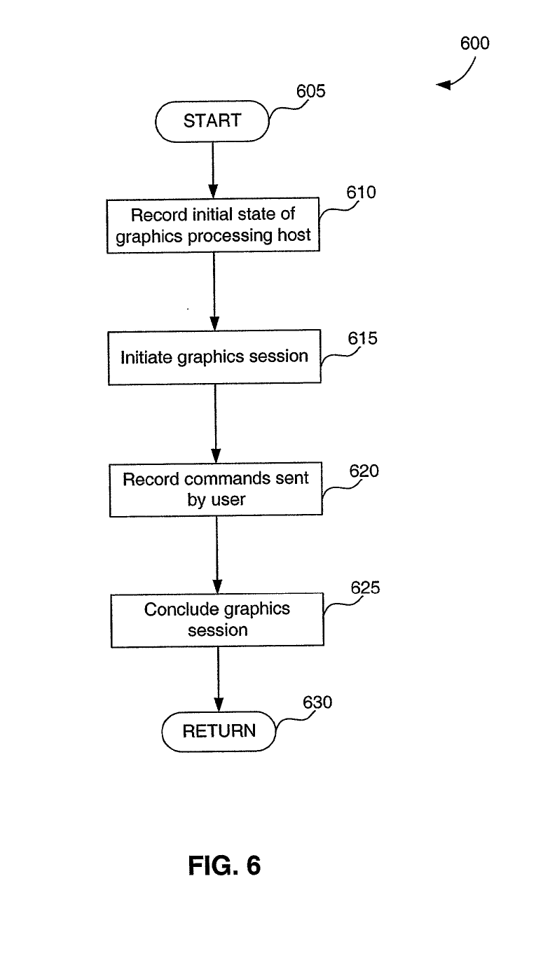

An alternative embodiment of the method of the invention is shown in FIG. 6 as method 600. Here the graphics information recorded includes the initial state of the graphics processing host and the commands by which the graphics session is controlled. The method begins with step 605. In step 610, the initial state of the graphics processing host is recorded. The initial state of the host includes the graphics data that will be used in the rendering process. In step 615, the graphics session is initiated. In step 620, commands sent by the user to direct the graphics session are recorded. In step 625, the graphics session is concluded. The method ends at step 630.

Conclusion

While various embodiments of the present invention have been described above, it should be understood that they have been presented by way of example, and not limitation. It will be apparent to persons skilled in the relevant art that various changes in detail can be made therein without departing from the spirit and scope of the invention. Thus the present invention should not be limited by any of the above-described exemplary embodiments, but should be defined only in accordance with the following claims and their equivalents.

What is claimed is:

1. A method of automatically capturing a graphics session, comprising the steps of:
(a) engaging in the graphics session; and
(b) automatically recording graphics information that can be used to re-create a display of image data rendered in the graphics session.

2. A method of claim 1, wherein the graphics session is controlled by a remote user.

3. A method of claim 1, wherein said step (b) comprises recording the image data that is output by a rendering process during the graphics session.

4. The method of claim 3, wherein said recording takes place at a client computer from which the graphics session is controlled.

5. The method of claim 3, wherein said recording takes place at a graphics processing host at which the image data is rendered.

6. The method of claim 5, wherein the image data is compressed prior to recording.

7. The method of claim 1, wherein said step (b) comprises:
(i) recording an initial state of a graphics processing host at which the image data is to be rendered; and
(ii) recording commands sent by a user to control the graphics session.

8. The method of claim 7, wherein said initial state of the graphics processing host comprises graphics data to be rendered.

9. The method of claim 1, further comprising the step of:
re-creating the display of the image data, performed after said recording step.

10. The method of claim 9, further comprising the step of:
analyzing the graphics session on the basis of said re-creation to facilitate debugging of a graphics application.

11. A system for automatically capturing a graphics session, comprising:
a recording medium;
a data path through which said recording medium automatically receives graphics information that can be used to re-create a display of image data rendered in the graphics session.

12. The system of claim 11, wherein said recording medium comprises at least one of:
a hard disk;
a floppy disk;
a magnetic tape;
a random access memory device; and
a compact disk.

13. The system of claim 11, wherein said graphics information comprises said image data rendered in said graphics session.

14. The system of claim 13, wherein said image data is compressed prior to recording.

15. The system of claim 11, wherein said graphics information comprises:
an initial state of a graphics processing host at which said image data is rendered; and
commands sent by a user to direct said graphics session.

16. The system of claim 15, wherein said initial state of said graphics processing host comprises graphics data to be rendered.
